(19) United States
(12) Patent Application Publication
(10) Pub. No.: US 2013/0188096 A1
(43) Pub. Date: Jul. 25, 2013

(54) Low-Overhead Processing of Video In Dedicated Hardware Engines

(71) Applicants: Purushotam Kumar, Bangalore (IN); Hardik Tushar Shah, Bangalore (IN); Sivaraj Rajamonickam, Bangalore (IN); Brijesh Rameshbhai Jadav, Bangalore (IN)

(72) Inventors: Purushotam Kumar, Bangalore (IN); Hardik Tushar Shah, Bangalore (IN); Sivaraj Rajamonickam, Bangalore (IN); Brijesh Rameshbhai Jadav, Bangalore (IN)

(73) Assignee: TEXAS INSTRUMENTS INCORPORATED, Dallas, TX (US)

(21) Appl. No.: 12/881,571

(22) Filed: Sep. 14, 2010

(30) Foreign Application Priority Data
Sep. 14, 2002 (IN) 2207/CHE/2009

(51) Int. Cl. H04N 9/67

(52) U.S. Cl. CPC H04N 9/67
USPC 348/660

(57) ABSTRACT

This invention allows the application software to submit multiple (N) frames belonging to different and/or same channels in one submission. The driver maintains a request queue and serializes requests and manages the hardware utilization. The driver informs the software through a callback function when the entire submission has been serviced.

### CLAIM OF PRIORITY

This application claims priority under 35 U.S.C. 119(a) to Indian Patent Application No. 2207/CHE/2009 filed Sep. 14, 2002.

### TECHNICAL FIELD OF THE INVENTION

The technical field of this invention is video processing in hardware engines.

### BACKGROUND OF THE INVENTION

The field of this invention is the software overheads and the hardware utilization when using a hardware engine to process multiple channels (or contexts) of video and multiple frames of video per channel. The integration of such hardware engines in microprocessors running on high level operating systems demands that the hardware engine should be managed by a software driver.

Conventional drivers generally permit the application software to submit only one frame at a time. The software operating on video streams thus makes multiple submissions, one per frame. When each submission is completed, the hardware typically issues an interrupt once per submission. When systems are managing one or two channels of processing, the overhead of submission and managing the completion interrupt is generally not a problem. Multichannel video systems and aggregators must deal with hundreds of channels. Software models for batch processing these plural channels in hardware engines have not yet been conceived.

The standard driver models in conventional high level operating systems provide seamless interface between the hardware and the software but not designed to maximize the utilization of the hardware. Accordingly, the hardware engine is not utilized as highly as feasible in the prior art.

### SUMMARY OF THE INVENTION

This invention allows the application software to submit multiple (N) frames belonging to different and/or same channels in one submission. The driver maintains a request queue and serializes requests and manages the hardware utilization. The driver informs the software through a callback function when the entire submission has been serviced.

### BRIEF DESCRIPTION OF THE DRAWINGS

These and other aspects of this invention are illustrated in the drawings, in which:

FIG. 1 illustrates an electronic device known in the prior at to which this invention is applicable;

FIG. 2 illustrates a system overview of a prior art video processing engine driver;

FIG. 3 illustrates an example of hardware utilization according to the prior art video processing engine driver illustrated in FIG. 2;

FIG. 4 illustrates a system overview of a video processing engine driver of one embodiment of this invention; and

FIG. 5 illustrates an example of hardware utilization according to the video processing engine driver of this invention illustrated in FIG. 4.

### DETAILED DESCRIPTION OF PREFERRED EMBODIMENTS

This invention is useful in signal processing including video processing where the input and output signals are video files or video streams. Applications of video processing include digital video discs (DVDs) and video players. The processing of video is performed using a hardware video processing engine (VPE). The VPE receives requests from multiple channels for processing one or more functions. A VPE driver provides the interface to an application program enabling use of the VPE for the video processing functions. The functions include de-interlacing and noise filtering of the video streams.

Existing models of the VPE driver provide an interface between an application program and the VPE. In the prior art, the VPE driver interface accepts one channel per request and the application program has to call the driver number of times for each channel. After completion of the request, a prior art VPE generates a call back to the application program usually via an interrupt.

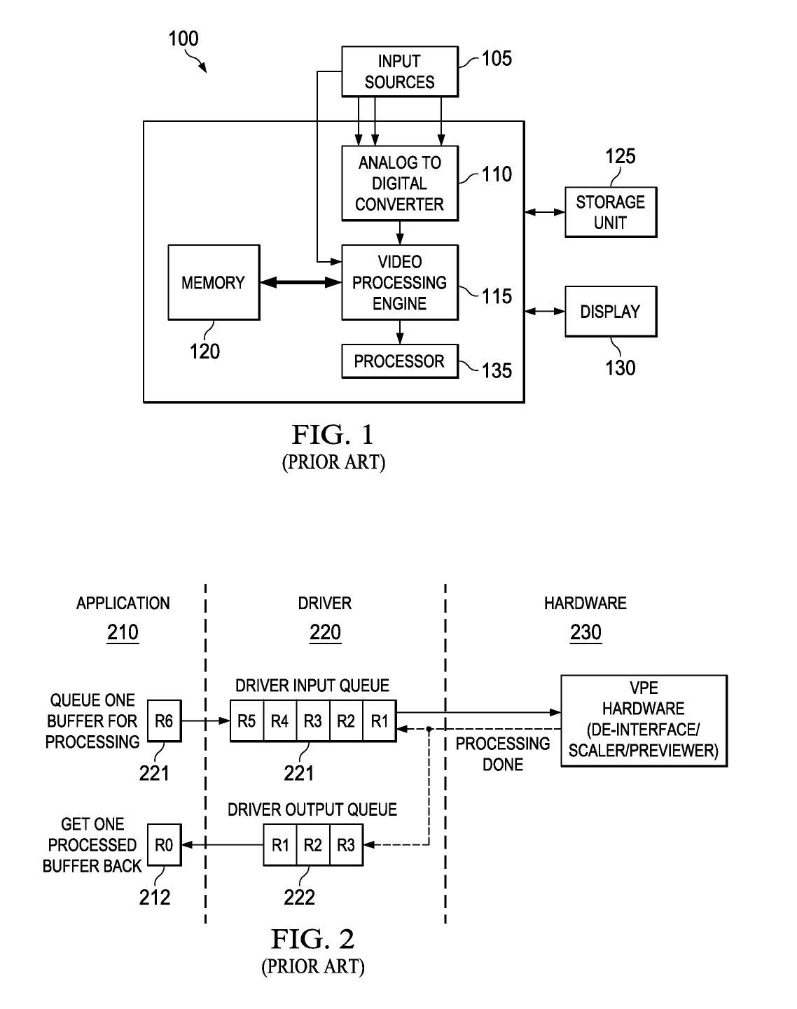

FIG. 1 illustrates an example electronic device 100 to which this invention is applicable. Electronic device 100 may embody a digital video recorder/player, a mobile phone, a television, a laptop or other computer or a personal digital assistants (PDAs). A plurality of input sources 105 feeds video to an analog-to-digital converter (ADC) 110. Examples of input sources 105 include a digital camera, a camcorder, a portable disk, a storage device, a USB or any other external storage media. ADC 110 converts the video feeds into digital data and supplies the digital data to video processing engine (VPE) 115. As illustrated in FIG. 1, video feeds can be directly provided to the VPE 115 from the input sources 105. The VPE 115 receives the digital data corresponding to each video frame of the video feed and stores the data in a memory 120. Multiple frames are stored corresponding to a video channel in a block of memory locations. An application retains pointers to the block of memory locations corresponding to the channel. The application can request the VPE perform different functions for different channels. As an example, a video stream coming from a camera to be down scaled from 1920 by 1080 pixels to 720 by 480 pixels and a second video stream coming from a hard disk or a network may be upscaled from 352 by 288 pixels to 720 by 480 pixels. The application can also perform one or more functions such as indicating size of the input video, indicating size of the output video or indicating a re-sizing operation to be performed by the VPE 115. Re-sizing can include upscaling, downscaling and cropping of frames dependent on various factors such as image resolution. For example, two input videos having 720 by 480 pixel frames can be re-sized into output videos of 352 by 240 pixel frames by the VPE 115. The input videos can then be combined and provided to a display 130 through a communication channel. The re-sized output videos can also be stored in memory 120. In some embodiments, a processor 135 in communication with the VPE 115 includes the application that performs the one or more functions. Examples of a processor 135 includes a central processing unit and a digital signal processor capable of program controlled data processing operations.

In some embodiments, some of the functioning of the VPE 115 can also be performed by processor 135 in connection with VPE 115. For example, the processor can support the application.

FIG. 2 illustrates a system overview of a video processing engine driver of the prior-art. This system includes application 210, driver 220 and VPE hardware 230. Application 210 and driver 220 represent programs running on VPE 115 or processor 135. VPE hardware 230 represents a hardware functional unit capable of defined frame image functions under control of driver 220. In accordance with this invention these image functions are generally operations on video frames. VPE driver 220 allows application 210 to submit one processing request at a time to VPE hardware 230. As illustrated in FIG. 2 the requested processes performed by VPE hardware 230 include de-interlacing, scaling/resizing and previewing. As noted above the requested process may include noise filtering. Each submission consists of only one frame. VPE 220 driver thus has to be called multiple times for multiple processing requests.

Application 210 places each request in request queue 211. Application 210 may run on VPE 115 or on processor 135. FIG. 2 illustrates an example request queue 211 as a single buffer R6. Each submitted request includes the corresponding video data to be processed or pointers to where that data is stored such as in memory 120 or storage unit 124 and control information enabling the VPE hardware 230 to perform the desired operation. VPE driver 220 maintains driver input queue 221. Driver input queue 221 stores and serializes the requests for access to VPE hardware 230. FIG. 2 illustrates an example driver input queue 221 as including five buffers R1 to R5. Requests enter driver input queue 221 via buffer R5 and are supplied to VPE hardware 230 via buffer R1.

VPE hardware 230 services requests from driver input buffer 221 one at a time in the order received. After processing of each request, VPE hardware 230 issues a call-back function (Processing Done) to VPE driver 220 indicating the end of processing function. The resulting processed data is stored and serialized in driver output queue 222. FIG. 2 illustrates an example driver output queue 222 including three buffers R1 to R3. VPE driver 220 in turn notifies application 210. This notification is generally via an interrupt. In the prior art such an interrupt occurs once per submission. The overhead of each request includes time to change a channel from user mode to driver mode. Overhead can occur during submission of a request to VPE hardware 230 and during processing. Overhead becomes significant in VPEs 115 or processors 135 that run at high clock rates such as 75 mega pixels per second to 250 mega pixels per second.

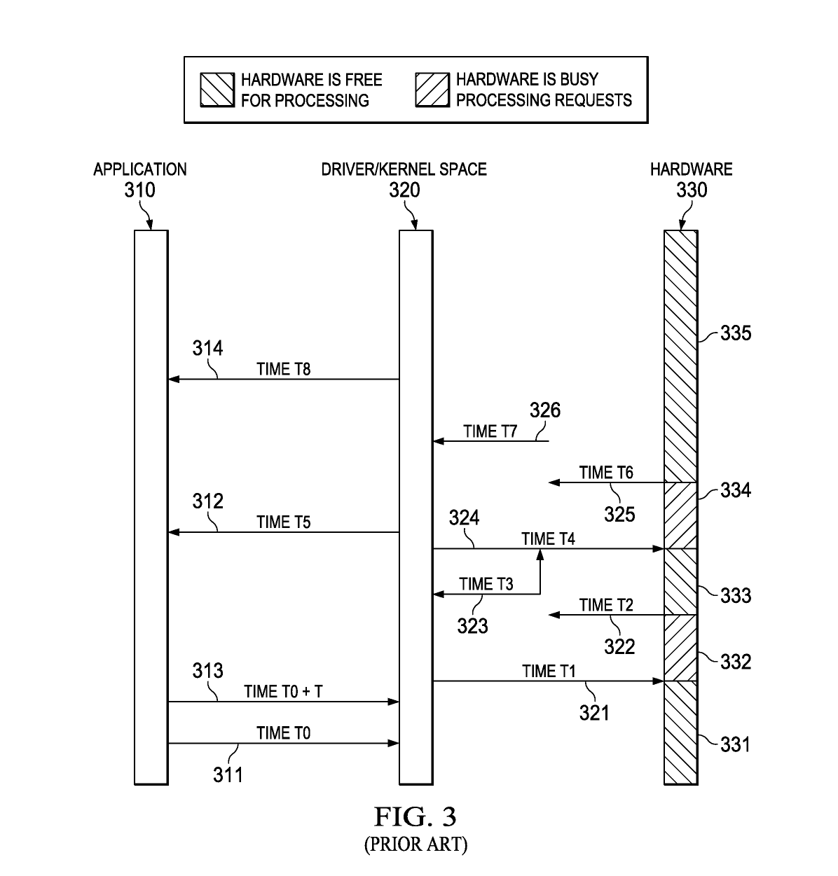

FIG. 3 illustrates the overhead of the prior art. FIG. 3 is divided into three parts: application 310; driver/kernel space 320; and hardware 330. These three parts correspond to application 210, driver 220 and VPE hardware 230 illustrated in FIG. 2. FIG. 3 further illustrates operation timing.

Application 310 issues request R1 at time T0 311 to driver/kernel space 320. Referring back to FIG. 2, the request is transferred from queue 211 of application 210 to driver input queue 221 of driver 220. At time T1 321 driver/kernel space 320 communicates a data processing request and the necessary data to hardware 330. Referring back to FIG. 2, the request is transferred from driver input queue 221 of driver 220 to VPE hardware 230. Hardware 330 is initially idle during an interval 331 before receipt of the data processing request. As a result of this request, hardware 330 is busy during an interval 332 performing the requested operation.

At the end of busy interval 332 at time T2 322, hardware 330 produces the results of the first request. Hardware 330 communicates to driver/kernel space 320 at time T3 323. Driver/kernel space 320 communicates these results back to application 310 at time T5 313.

During the resulting time, at time T0+T 313 application 310 issues another request R2 to driver/kernel space 320. Driver/kernel space 320 cannot immediately supply this request to hardware 330 because hardware 330 is busy with the prior request. Driver/kernel space 320 communicates a data processing request and the necessary data to hardware 330 at time T4 324. Hardware 330 is initially idle during an interval 333 between completion of processing of the first request R1 at time 322 and receipt of the next data processing request at time T4 324. As a result of this request, hardware 330 is busy during an interval 334 performing the requested operation. At the end of busy interval 334 at time T6 325, hardware 330 produces the results of the second request. Hardware 330 communicates to driver/kernel space 320 at time T7 326. Driver/kernel space 320 communicates these results back to application 310 at time T9 314. Following completion of servicing the second request R2, hardware 330 is idle during an interval 335.

The time to complete N requests by the VPE is given by:

N*(Tₛ+Tₕ)

where: Tₛ is the time for software overhead which is Tₛₐ+T_{sd}; Tₛₐ is the application to driver overhead; T_{sd} is the driver overhead; and Tₕ is the actual hardware processing time.

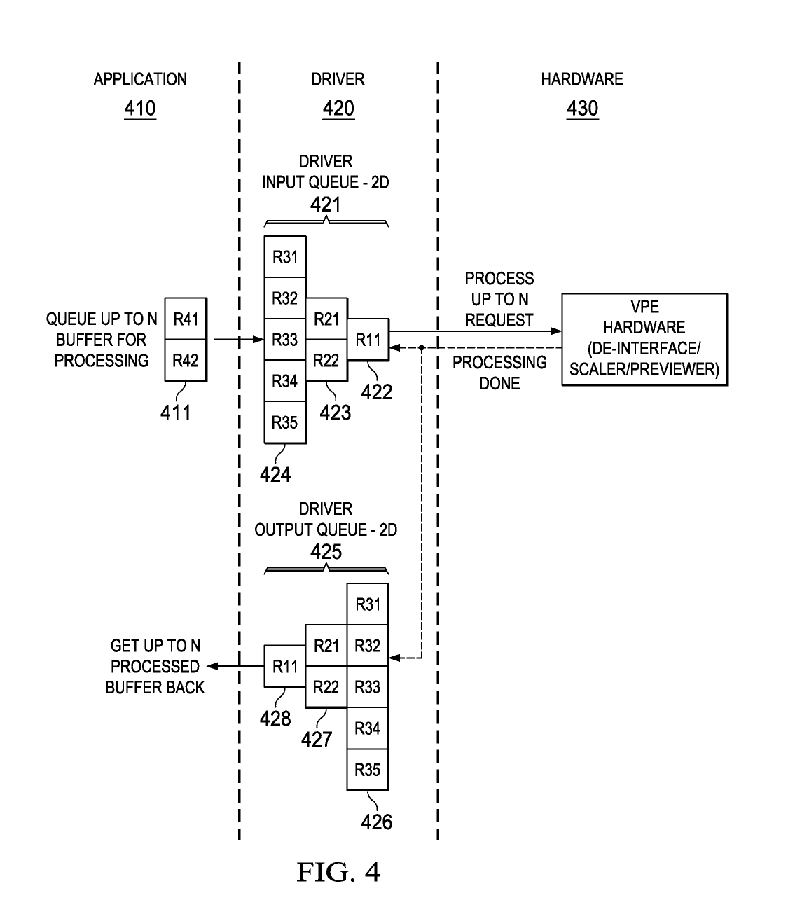

FIG. 4 illustrates a system overview of a video processing engine (VPE) driver in accordance with one embodiment of this invention. This system includes application 410, driver 420 and VPE hardware 430. These parts operate similarly to application 210, driver 220 and VPE hardware 230 illustrated in FIG. 2 except as noted below. VPE driver 420 permits application 410 to submit N multiple requests at a time. As illustrated in FIG. 4 the requested processes include de-interlacing, scaling/resizing and previewing. As noted above the requested process may include noise filtering. Each submission may include M multiple frames belonging to different channels. Each channel may have a different set of parameters to be operated by VPE 115. In the preferred embodiment the value of M varies from 1 to 64. In other embodiments, the value of M may be greater than 64.

Application 410 places each request in request queue 411. FIG. 4 illustrates an example request queue 411 including two buffers R41 and R42. Driver 420 maintains driver input queue 421 which stores and serializes the requests for access to hardware 430. FIG. 4 illustrates an example driver input queue 421 as including three channels of buffers 422, 423 and 424. Channel 422 includes a single buffer R11 for storing a single request. Channel 423 includes two buffers R21 and R22 capable of storing two request. Channel 424 includes five buffers R31, R32, R33, R34 and R35 capable of storing five requests. Requests enter driver input queue 421 via buffer layer 424 and are supplied to VPE hardware 430 via buffer layer 422.

VPE hardware 430 services the requests received from driver input queue 421. After processing of all M Frames in a request, VPE hardware 430 issues a call-back function (Processing Done) to driver 420 indicating the end of processing function. The resulting processed data is stored in serialized in driver output buffer 425. FIG. 4 illustrates an example driver output queue 425 as including three channels 426, 427 and 428. Channel 426 includes five buffers R31, R32, R33, R34 and R35 for the five requests of the corresponding channel 424 in driver input queue 421. Channel 427 includes two buffers R21 and R22 for the two requests of the corresponding channel 423 in driver input queue 421. Buffer layer 428 includes a single buffer R11 for the single request of the corresponding channel 422 of driver input queue 421. Requests enter driver output queue 425 from VPE hardware 430 and are supplied to application 410. Driver 420 also notifies application 410 preferably via an interrupt. In accordance with this invention, only one interrupt is generated after processing M frames. Multiple sets of such N requests can be submitted at a time.

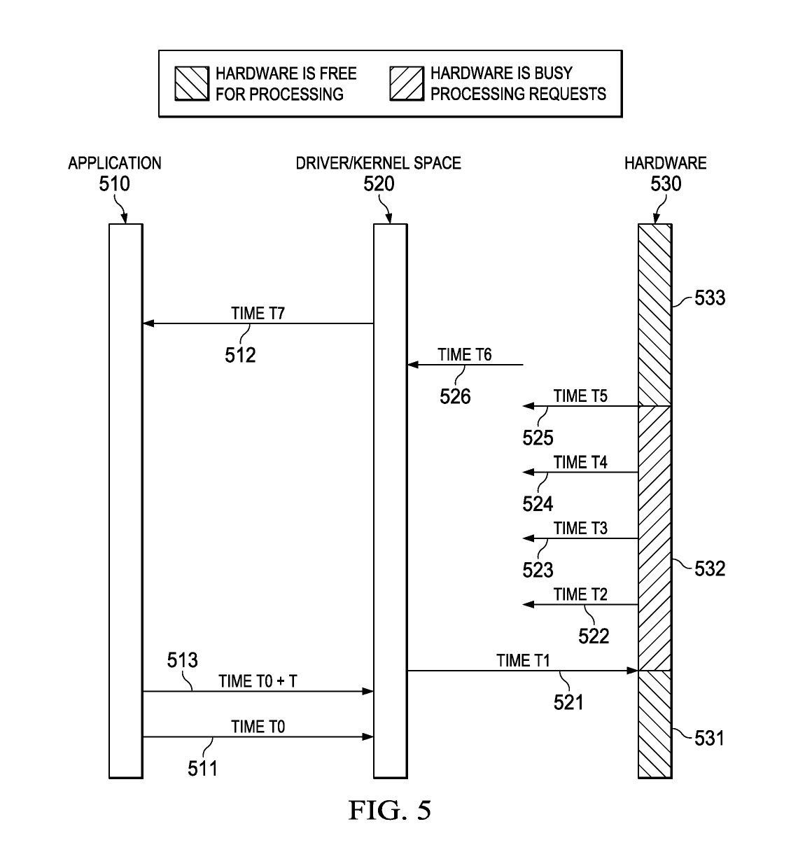

FIG. 5 illustrates the overhead of this invention. FIG. 5 is divided into three parts: application 510; driver/kernel space 520; and hardware 530. These three parts correspond to application 410, driver 420 and VPE hardware 430 illustrated in FIG. 4. FIG. 5 further illustrates operation timing.

Application 510 issues a combined request R1, R2, R3 and R4 at time T0 511 to driver/kernel space 520. Referring back to FIG. 4, the request is transferred from queue 411 of application 410 to driver input queue 421 of driver 420. At time T1 521 driver/kernel space 520 communicates a data processing request and the necessary data to hardware 530. Referring back to FIG. 4, the request is transferred from driver input queue 421 of driver 420 to VPE hardware 430. Depending on the function desired and the capability of hardware 530 the plural requests may include requests from plural channels 422, 423 and 424 of plural requests from a single channel such as requests R31, R32 and R33 from channel 424 or a combination.

Hardware 530 is initially idle during an interval 531 before receipt of the data processing request. As a result of this request, hardware 530 is busy during an interval 532 performing the requested operation on the M frames.

During busy interval 532 at time T2 522, hardware 530 produces the results of the first request R1. Similarly also during busy interval 532 at time T3 523, hardware 530 produces the results of the second request R2. Hardware 530 produces results of the third request R3 at time T4 524 and the results of the fourth request R4 at time T5 525. Hardware 530 communicates to driver/kernel space 520 at time T6 526. Driver/kernel space 520 communicates these results back to application 510 at time T7 512.

During this interval time, at time T0+T 513 application 510 issues another request R5 to driver/kernel space 520. Driver/kernel space 520 cannot immediately supply this request to hardware 530 because hardware 530 is busy with the prior requests. Driver/kernel space 320 communicates a data processing request and the necessary data to hardware 330 at time T4 324. Hardware 530 is idle during an interval 533 following between completion of processing of the set of first requests R1, R2, R3 and R4. Driver/kernel space 520 dispatches this next request ending idle interval 533 (not shown in FIG. 5).

The time to complete N requests using the processing engine of this invention is given by:

Tₛ+N*Tₕ

where: Tₛ is the time for software overhead which is Tₛₐ+T_{sd}; Tₛₐ is the application to driver overhead; T_{sd} is the driver overhead; and Tₕ is the actual hardware processing time. This invention is advantageous over the prior art by requiring the software overhead Tₛ less frequently. This invention incurs the software overhead Tₛ only once per N requests rather than on each request.

Table 1 is a comparison of the overhead incurred in the prior art and in this invention. The first row of Table 1 corresponds to the overhead calculations above. The second row of Table 1 shows the hardware utilization factor for N frames.

TABLE 1

| | Prior Art | Invention |
|---|---|---|
| Time to service N | N*(Tₛ + Tₕ) | Tₛ + N*Tₕ |
| requests on one VPE | | |
| Hardware utilization | (N*Tₕ)/(N*(Tₛ + Tₕ)) = | (N*Tₕ)/(Tₛ + N*Tₕ) |
| factor on one VPE | Tₕ/(Tₛ + Tₕ) | |

Table 1 shows the hardware utilization factor in the prior art approaches 1 (100% utilization) only as Tₕ becomes large relative to Tₛ. Table 1 shows that the hardware utilization factor in this invention approaches 1 as N becomes larger.

Table 2 shows a comparison of hardware utilization of a prior art example product and the predicted hardware utilization of this invention for example processes. Table 2 shows the hardware overhead Tₕ and the software overhead Tₛ for each of the example tasks.

TABLE 2

| | | | | Hardware |
|---|---|---|---|---|
| | | | Hardware | Utilization |
| | Tₕ | Tₛ | Utilization | invention |
| Test Cases | μsec | μsec | prior art | (predicted) |
| Resizer VGA | 2048 | 800 | 72% | 97% |
| resolution N = 16 | | | | |
| Resizer CIF | 675 | 750 | 47% | 93% |
| resolution N = 16 | | | | |
| Resizer CIF | 675 | 750 | 47% | 96% |
| resolution N = 32 | | | | |

The last two rows of Table 2 show that as N increases for the same operation, the hardware utilization approaches 100%.

Table 2 shows that the overhead can be decreased up to 35% compared to the prior art. With increase in value of N, the hardware efficiency can be improved towards 100%. The proposed VPE driver also allows more number of VPEs to be controlled by a single central processing unit. If a central processing unit (CPU) controls software scheduling of the VPE engine(s), since the software overhead has come down the same number of VPEs could be controlled with a less powerful CPU. Alternately, the using the same CPU frequency, more VPEs could be controlled. As another alternative, the CPU processing capability saved using this invention could be used for other CPU intensive processing tasks like video encode/decode.

To get maximum utilization using this invention, the VPE hardware should support submission of multiple frames/streams at a time. If hardware does not support multiple submissions, this invention may still be useful. Using this invention will avoid incurring the driver software overhead every submission as required by prior art VPE drivers. This invention avoids incurring the as application to driver software overhead Tₛₐ every frame. Only the software overhead T_{sd} of programming the hardware registers is present. This allows previously designed VPE engines to use this invention. All new designs of VPE engines should support multiple submission to get the maximum benefit out of this invention.

A further embodiment of this invention reduces the latency of the bundled requests. Rather than require them to service requests in submission order driver 420 could submit requests using a priority system. This reduces latency for real time (high priority) requests at the expense of low priority requests. Latency can be avoided using intermediate call-backs. The request partial results occurring at times T2 522, T3 523, T4 524 and T5 525 could be immediately communicated to application 510 rather than being bundled.

Those skilled in the art will recognize that a wide variety of modifications, alterations, and combinations can be made with respect to the above described embodiments without departing from the scope of the present disclosure, and that such modifications, alterations, and combinations are to be viewed as being within the ambit of the inventive concept.

The foregoing description sets forth numerous specific details to convey a thorough understanding of embodiments of the present disclosure. However, it will be apparent to one skilled in the art that embodiments of the present disclosure may be practiced without these specific details. Some well-known features are not described in detail in order to avoid obscuring the present disclosure. Other variations and embodiments are possible in light of above teachings, and it is thus intended that the scope of present disclosure not be limited by this detailed description.

What is claimed is:

1. A method of operating an electronic device including a program controlled data processor and at least one video processing hardware responsive to requests to perform operations on video frames, the method comprising the steps of:
forming a request for an operation on plural video frames using an application program running on the data processor;
submitting the request of the application program to the video processing hardware for the plural video frames using a driver;
notifying the application program when the video processing hardware has completed a submitted request.

2. The method of claim 1, wherein:
each request includes data corresponding to the plural video frames.

3. The method of claim 1, wherein:
each request includes pointers to a location in memory storing data corresponding to the plural video frames.

4. The method of claim 1, wherein:
the video processing hardware is capable of performing operations on video frames of plural types; and
each request indicates a type of operation to be performed.

5. The method of claim 1, wherein:
said step of notifying the application program includes
the video processing hardware notifying the driver that processing a request is complete, and
the driver notifying the application program that processing a request is complete.

6. The method of claim 5, wherein:
said step of the driver notifying the application program includes issuing an interrupt to the application program.

7. The method of claim 1, wherein:
the operation on video frames of the video processing hardware includes de-interlacting a video frame.

8. The method of claim 1, wherein:
the operation on video frames of the video processing hardware includes scaling a video frame.

9. The method of claim 1, wherein:
the operation on video frames of the video processing hardware includes re-sizing a video frame.

10. The method of claim 1, wherein:
the operation on video frames of the video processing hardware includes previewing a video frame.

11. The method of claim 1, wherein:
the operation on video frames of the video processing hardware includes cropping a video frame.

12. The method of claim 1, wherein:
the operation on video frames of the video processing hardware includes noise filtering a video frame.
